(19) United States
(12) Patent Application Publication
(10) Pub. No.: US 2008/0006295 A1
(43) Pub. Date: Jan. 10, 2008

(54) Semiconductor manufacturing apparatus for use in process of cleaning semiconductor substrate and method of manufacturing semiconductor device using the same

(76) Inventors: Kunihiro Miyazaki, Yokohama-shi (JP); Hiroaki Yamada, Yokohama-shi (JP); Hiroshi Tomita, Yokohama-shi (JP); Hajime Onoda, Kawasaki-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/542,201

(22) Filed: Oct. 4, 2006

(30) Foreign Application Priority Data
Jul. 5, 2006 (JP) 2006-185896

(51) Int. Cl. C23G 1/00; C23G 1/02; B08B 3/00

(52) U.S. Cl. 134/3; 134/94.1; 134/2; 134/26

(57) ABSTRACT

A processing tank stores heated sulfuric acid, and a semiconductor substrate having resist formed thereon and to be processed is immersed in the heated sulfuric acid. A first introduction unit introduces ozone gas into the sulfuric acid stored in the processing tank. A second introduction unit introduces hydrogen peroxide into the solution containing sulfuric acid and ozone at least before the processing of the semiconductor substrate is completed.

### CROSS-REFERENCE TO RELATED APPLICATIONS

This application is based upon and claims the benefit of priority from prior Japanese Patent Application No. 2006-185896, filed Jul. 5, 2006, the entire contents of which are incorporated herein by reference.

### BACKGROUND OF THE INVENTION

1. Field of the Invention

The present invention relates to a method of manufacturing a semiconductor device, and for example, relates to a semiconductor manufacturing apparatus for use in a cleaning process thereof, and a method of manufacturing the semiconductor device.

2. Description of the Related Art

In a process of manufacturing a semiconductor device, for example, resist is used as a mask material at the time of the formation of wiring patterns. The resist is used for etching the wiring patterns and for implanting impurities into the required part of the semiconductor device by use of an ion implantation apparatus. After these processes are completed, the resist which has become unnecessary is removed.

A conventional resist removing method is generally carried out by using a combination of an asher and chemical, or the asher or chemical alone. The resist removal by the chemical is generally carried out by SPM cleaning in which sulfuric acid is mixed with hydrogen peroxide solution. Also, SOM cleaning exists, which introduces ozone gas into the sulfuric acid (refer to, for example, Jpn. Pat. Appln. KOKAI Publication Nos. 2002-231683, 2002-231677 and 2004-327826). Furthermore, a cleaning method exists, which uses sulfuric acid chemical as a base, and combines the introduction or the like of hydrogen peroxide or ozone gas with the chemical (refer to, for example, JPn. Pat. Appln. KOKAI Publication Nos. 11-293288 and 2000-290693).

Thus, the SOM cleaning which introduces the ozone gas into the sulfuric acid can enhance the peeling performance of the resist since the SOM cleaning has higher sulfuric acid concentration and can be carried out at higher temperatures as compared with the SPM cleaning in which the sulfuric acid is mixed with the hydrogen peroxide solution. However, when peroxodisulfuric acid (or hydrogen peroxide) is little and dissolution due to the substance is required, a problem exists in that resist residue exists in solution indefinitely.

Examples of methods of enhancing the peeling performance of the resist include adding a peroxodisulfuric acid into a sulfuric acid-hydrogen peroxide mixture (refer to, for example, Jpn. Pat. Appln. KOKAI Publication No. 11-293288).

There has also been considered a method of adding the peroxodisulfuric acid or hydrogen peroxide capable of dissolving the resist into sulfuric acid/ozone capable of making it high temperature and having high sulfuric acid concentration by mixing to the sulfuric acid. However, as is well known, the hydrogen peroxide solution acts as a reducing agent to a stronger oxidizer than the hydrogen peroxide solution, and decomposes the ozone in the liquid. For this reason, when the hydrogen peroxide solution is merely added into the sulfuric acid/ozone, the concentration of the ozone or hydrogen peroxide is reduced, and the peeling performance of the resist is reduced. Therefore, it is not a good plan to simply mix an oxidizer into the sulfuric acid/ozone.

Accordingly, there has been desired the provision of a semiconductor manufacturing apparatus which can dissolve the resist residue in the liquid efficiently by the introduction of the hydrogen peroxide solution without reducing the peeling performance of the resist due to the sulfuric acid/ozone (SOM) cleaning in which the ozone gas is introduced into the sulfuric acid, and a method of manufacturing a semiconductor device.

### BRIEF SUMMARY OF THE INVENTION

According to a first aspect of the invention, there is provided a semiconductor manufacturing apparatus comprising: a processing tank in which heated sulfuric acid is stored and a semiconductor substrate having resist formed thereon and to be processed is immersed; a first introduction unit which introduces ozone gas into the sulfuric acid stored in the processing tank; and a second introduction unit which introduces hydrogen peroxide into the solution containing the sulfuric acid and ozone at least before the processing of the semiconductor substrate is completed.

According to a second aspect of the invention, there is provided a semiconductor manufacturing apparatus comprising: a processing tank in which sulfuric acid is stored and a semiconductor substrate having resist formed thereon and to be processed is immersed; a first introduction unit which introduces ozone gas into the sulfuric acid stored in the processing tank; a mixing tank provided in an exterior of the processing tank, the mixing tank storing the solution containing sulfuric acid and ozone overflowed from the processing tank; a heating unit which heats the solution supplied from the mixing tank, the heating unit supplying the solution to the processing tank; and a second introduction unit which introduces hydrogen peroxide into the sulfuric acid at least before the processing of the semiconductor substrate is completed.

According to a third aspect of the invention, there is provided a method of manufacturing a semiconductor device, comprising: introducing ozone gas into heated sulfuric acid and processing a semiconductor substrate having resist formed thereon using the solution containing sulfuric acid and ozone; and introducing hydrogen peroxide into the solution at least before the processing of the semiconductor substrate is completed to dissolve undissolved resist.

### BRIEF DESCRIPTION OF THE SEVERAL VIEWS OF THE DRAWING

FIG. 1 is a diagram showing a configuration according to an embodiment of a semiconductor manufacturing apparatus;

FIGS. 2A to 2E are respectively timing charts showing processing sequences of a semiconductor device using the apparatus shown in FIG. 1;

FIG. 3 is a characteristic diagram showing an example showing a lifetime according to the temperature of hydrogen peroxide in a sulfuric acid solution; and

FIG. 4 is a characteristic diagram showing an example showing a lifetime of hydrogen peroxide in a sulfuric acid solution in a different temperature from that of FIG. 3.

### DETAILED DESCRIPTION OF THE INVENTION

Hereinafter, an embodiment of the present invention will be described with reference to the drawings.

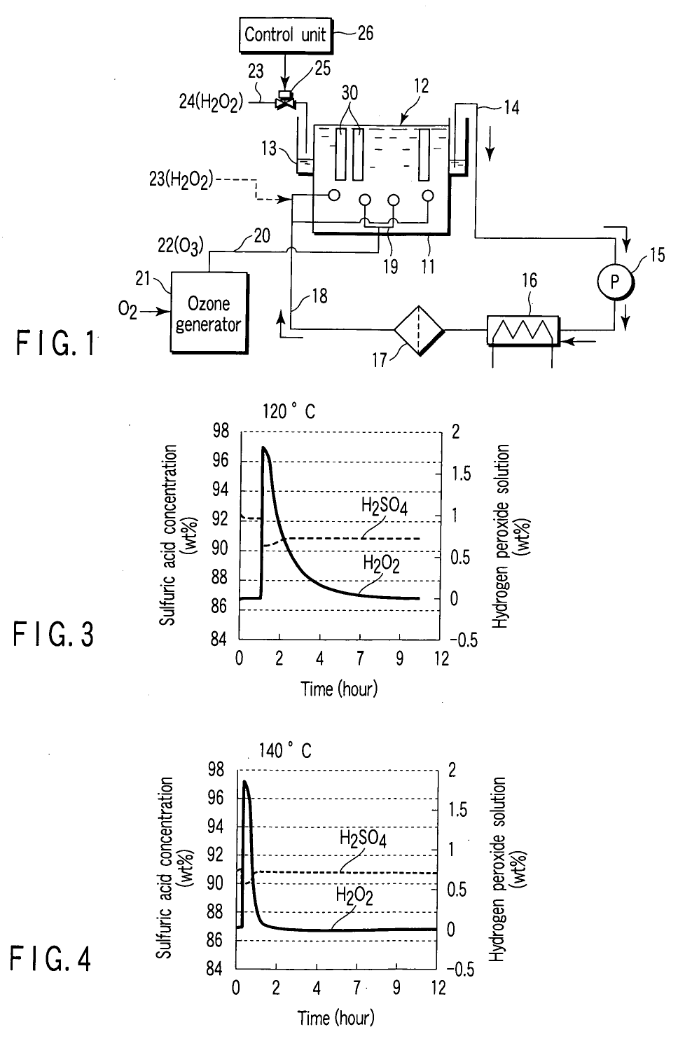

A semiconductor manufacturing apparatus according to an embodiment of FIG. 1 will be schematically shown. In FIG. 1, highly concentrated sulfuric acid 12 is stored in a processing tank 11 cleaning a semiconductor substrate. The concentration of the sulfuric acid 12 is, for example, 85% or more. The sulfuric acid 12 overflowed from the upper part of the processing tank 11 is stored in an outer tank 13 as a mixing tank provided in the exterior of the processing tank 11. That is, the outer tank 13 is provided at the periphery of the processing tank 11. The sulfuric acid 12 stored in the outer tank 13 is guided to a heater 16 by a pipe 14 and a circulating pump 15. The sulfuric acid 12 heated by the heater 16 is guided into the processing tank 11 via a filter 17 and a pipe 18. Although the filter 17 for removing particles is contained in a circulating system, the filter 17 may be inserted in the system if necessary. A bubbler 19, which is provided in the processing tank 11, is connected to an ozone generator 21 via a pipe 20. The ozone generator 21 generates ozone gas (O₃) 22 from, for example, supplied oxygen O₂. The generated ozone gas 22 is introduced into the sulfuric acid 12 of the processing tank 11 via the pipe 20 and the bubbler 19. A mechanism for introducing the ozone gas is not limited to the bubbler 19, and an ejector can be also used for the mechanism. Furthermore, hydrogen peroxide (H₂O₂) 24 is introduced into the outer tank 13 via a pipe 23. A valve 25, which is provided on the way of the pipe 23, is controlled by a control unit 26. As described later, the control unit 26 controls the supply timing and supply amount of hydrogen peroxide to a sulfuric acid solution. Furthermore, the control unit 26 may control the heater 16 to control the temperature of the sulfuric acid solution stored in the processing tank 11 and the operation of the ozone generator 21. The hydrogen peroxide 24 is mixed with the sulfuric acid solution in the outer tank 13, is heated by the heater 16, and is guided into the processing tank 11. The introduction position of the hydrogen peroxide to the sulfuric acid solution is not limited to the outer tank 13. For example, the hydrogen peroxide may be introduced to the inner side of the processing tank 11, the circulating pump 15, the heater 16, the filter 17 or the circulating system pipe 18 as shown by a dashed line in FIG. 1.

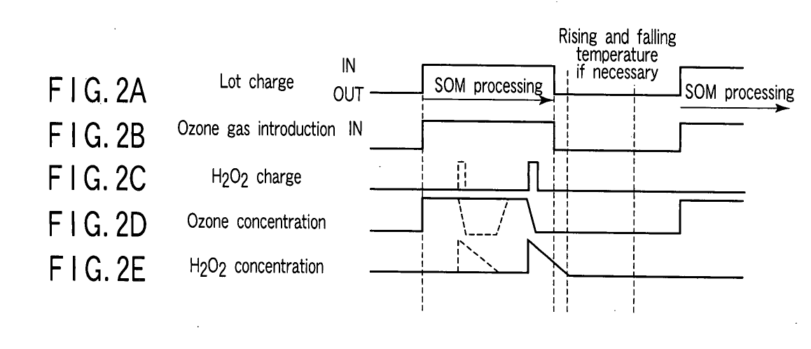

In the above configuration, a method of cleaning a substrate will be described with reference to FIG. 2.

The highly concentrated sulfuric acid 12 is stored in the processing tank 11 for cleaning the semiconductor substrate. The sulfuric acid 12 overflowed from the processing tank 11 is guided to the heater 16 by the circulating pump 15, and is circulated to the processing tank 11 via the filter 17 while the sulfuric acid 12 is heated to a high temperature. The sulfuric acid 12, which is heated to, for example, 130 to 180° C., is circulated. The ozone gas 22 generated by the ozone generator 21 is introduced into the processing tank 11 via the pipe 20 and the bubbler 19.

As shown in FIG. 2A, for example, simultaneously with immersing the semiconductor substrate (lot) on which the resist is formed in the processing tank 11, as shown in FIG. 2B, the ozone gas is introduced into the sulfuric acid 12 of the processing tank 11. However, the introduction timing of the ozone gas can be also set earlier or later to some degree than the immersion of the semiconductor substrate into the processing tank 11. Fundamentally, the processing of the semiconductor substrate in a mixed state of sulfuric acid/ozone may be the same timing as the resist removing process.

Although the resist formed on the semiconductor substrate can be effectively peeled by the sulfuric acid and ozone processes, the solution rate of the resist may be reduced according to the increase in the amount of the resist peeled in the sulfuric acid solution to cause the existence of the resist residue in the sulfuric acid solution. In this case, when the resist is newly peeled in the next processing of the semiconductor substrate, the resist residue may remain in the sulfuric acid solution. Or when the semiconductor substrate is taken out from a cleaning fluid after the peeling of the resist is completed, the undissolved resist residue may be adhered to the semiconductor substrate.

So, in the embodiment, in order to dissolve the undissolved resist using the mixed solution of the sulfuric acid having a rapid solution rate of the resist and hydrogen peroxide, hydrogen peroxide solution is added at least before taking out the semiconductor substrate. That is, as shown in FIG. 2C, the hydrogen peroxide solution is added into the sulfuric acid solution of the processing tank 11 for a short interval of time before the processing of the semiconductor substrate is completed. The dissolved ozone in the sulfuric acid develops a redox reaction with the hydrogen peroxide, and is decomposed. Therefore, at least the amount of the hydrogen peroxide to be added need only be the sum of the amount required for the decomposition of the ozone and amount required for the dissolution of the resist residue. The concentration of the hydrogen peroxide to be added is, for example, 0.01 to 2 wt %. As shown in FIG. 2D, the ozone concentration is reduced by the addition of the hydrogen peroxide, and as shown in FIG. 2E, the concentration of the hydrogen peroxide is reduced with time.

Thus, the undissolved resist can be dissolved by adding the hydrogen peroxide into the sulfuric acid/ozone solution before the processing of the semiconductor substrate is completed. Thereby, the undissolved resist in the solution can be efficiently dissolved. In addition, since the addition time of the hydrogen peroxide is a short period before the processing is completed, the addition has an advantage that the peeling performance of the resist due to the sulfuric acid solution is not reduced.

When, after the semiconductor substrate processing (SOM cleaning), the hydrogen peroxide exists in the processing tank 11 in the case of the next semiconductor substrate processing (SOM cleaning), the introduced ozone is decomposed. For this reason, as shown in FIG. 2E, the hydrogen peroxide must be fully decomposed, for example, for tens of minutes till the next processing of the semiconductor substrate. The decomposition rate of the hydrogen peroxide in the high-temperature sulfuric acid solution also depends on temperature. As shown in FIG. 3, the hydrogen peroxide exists at 120° C. for several hours, and by contrast, the hydrogen peroxide does not exist at 140° C. for 1 hour. In the manufacturing process of the semiconductor, the practical temperature of the sulfuric acid solution is 130° C. or more. The concentration of the hydrogen peroxide to be added is desirably about 0.01 to about 2 wt % in view of the experimental results.

In the above description, the hydrogen peroxide is introduced once in order to dissolve the residue of the resist in liquid at the end of the processing of the semiconductor substrate. However, the processing is not limited thereto.

For example, if the hydrogen peroxide is decomposed in several minutes, and the ozone concentration is immediately recovered during the processing, the hydrogen peroxide may be added several times during the processing, as shown by a dashed line in FIG. 2C. By doing this, the resist residue in the sulfuric acid solution can be suitably dissolved.

Furthermore, if required, the temperature of the sulfuric acid solution may be increased, and the temperature may be returned to the processing temperature after decomposing the hydrogen peroxide in order to increase the decomposition rate of the hydrogen peroxide between the processes of the semiconductor substrate.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A semiconductor manufacturing apparatus comprising:
a processing tank in which heated sulfuric acid is stored and a semiconductor substrate having resist formed thereon and to be processed is immersed;
a first introduction unit which introduces ozone gas into the sulfuric acid stored in the processing tank; and
a second introduction unit which introduces hydrogen peroxide into the solution containing the sulfuric acid and ozone at least before the processing of the semiconductor substrate is completed.

2. The apparatus according to claim 1, wherein the temperature of the sulfuric acid is 130 to 180° C., and the concentration of the hydrogen peroxide to be added to the sulfuric acid is 0.01 to 2 wt %.

3. The apparatus according to claim 1, wherein the second introduction unit introduces the hydrogen peroxide into the solution plural times during the processing of the semiconductor substrate.

4. The apparatus according to claim 1, further comprising a mixing tank provided in an exterior of the processing tank, the mixing tank storing the solution overflowed from the processing tank.

5. The apparatus according to claim 4, wherein the second introduction unit introduces the hydrogen peroxide into the solution stored in the mixing tank.

6. The apparatus according to claim 5, further comprising a control unit which controls the introduction timing of the hydrogen peroxide due to the second introduction unit.

7. The apparatus according to claim 6, wherein the control unit introduces the hydrogen peroxide into the mixing tank plural times by use of the second introduction unit before the processing of the semiconductor substrate is completed.

8. The apparatus according to claim 4, further comprising a heating unit arranged between the mixing tank and the processing tank, the heating unit heating the solution supplied from the mixing tank and supplying the heated solution to the processing tank.

9. A semiconductor manufacturing apparatus comprising:
a processing tank in which sulfuric acid is stored and a semiconductor substrate having resist formed thereon and to be processed is immersed;
a first introduction unit which introduces ozone gas into the sulfuric acid stored in the processing tank;
a mixing tank provided in an exterior of the processing tank, the mixing tank storing the solution containing sulfuric acid and ozone overflowed from the processing tank;
a heating unit which heats the solution supplied from the mixing tank, the heating unit supplying the solution to the processing tank; and
a second introduction unit which introduces hydrogen peroxide into the sulfuric acid at least before the processing of the semiconductor substrate is completed.

10. The apparatus according to claim 9, wherein the temperature of the sulfuric acid is 130 to 180° C., and the concentration of the hydrogen peroxide to be added to the sulfuric acid is 0.01 to 2 wt %.

11. The apparatus according to claim 9, wherein the second introduction unit introduces the hydrogen peroxide into the solution stored in the mixing tank.

12. The apparatus according to claim 11, further comprising a control unit which controls the introduction timing of the hydrogen peroxide due to the second introduction unit.

13. The apparatus according to claim 12, wherein the control unit introduces the hydrogen peroxide into the mixing tank plural times by use of the second introduction unit before the processing of the semiconductor substrate is completed.

14. A method of manufacturing a semiconductor device, comprising:
introducing ozone gas into heated sulfuric acid and processing a semiconductor substrate having resist formed thereon using the solution containing sulfuric acid and ozone; and
introducing hydrogen peroxide into the solution at least before the processing of the semiconductor substrate is completed to dissolve undissolved resist.

15. The method according to claim 14, wherein the temperature of the sulfuric acid is 130 to 180° C., and the concentration of the hydrogen peroxide to be added is 0.01 to 2 wt %.

16. The method according to claim 14, wherein the hydrogen peroxide is supplied into the solution plural times during the processing of the semiconductor substrate.
